(19) United States
(12) Patent Application Publication
(10) Pub. No.: US 2022/0253722 A1
(43) Pub. Date: Aug. 11, 2022

(54) RECOMMENDATION SYSTEM WITH ADAPTIVE THRESHOLDS FOR NEIGHBORHOOD SELECTION

(71) Applicants: Haolun WU, Montreal (CA); Chen MA, Montreal (CA); Yingxue ZHANG, Montreal (CA); Mark COATES, Montreal (CA)

(72) Inventors: Haolun WU, Montreal (CA); Chen MA, Montreal (CA); Yingxue ZHANG, Montreal (CA); Mark COATES, Montreal (CA)

(21) Appl. No.: 17/170,647

(22) Filed: Feb. 8, 2021

(51) Int. Cl. G06N 5/04; G06Q 30/06; G06N 20/00; G06F 17/16

(52) U.S. Cl. CPC G06N 5/04; G06F 17/16; G06N 20/00; G06Q 30/0631

(57) ABSTRACT

A recommendation system (RS) for processing an input dataset that identifies a set of users, a set of items, and user-item interaction data about historic interactions between users in the set of users and items in the set of items. The RS is configured to: generate, based on a user-item interaction dataset, a user-user similarity dataset and an item-item similarity dataset, filter the user-user similarity dataset based on a user similarity threshold vector that includes a respective user similarity threshold value for each user, filter the item-item similarity dataset based on an item similarity threshold vector including a respective item similarity threshold value for each item generate a set of user neighbour embeddings based on the filtered user-user similarity dataset, and generating a set of item neighbour embeddings based on the filtered item-item similarity dataset. The RS is also configured to generate a set of relevance scores based on the user neighbour embeddings and the item neighbour embeddings and generating a list of one or more recommended items for each user.

### RELATED APPLICATIONS

None

### FIELD

This disclosure relates generally to the processing of graph based data using machine learning techniques, particularly in the context of recommendation systems.

### BACKGROUND

An information filtering system is a system that removes redundant or unwanted information from an information stream that is provided to a human user in order to manage information overload. A recommendation system (RS) is a subclass of an information filtering system that seeks to predict the rating or preference a user would give to an item. RSs are often used in commercial applications to guide users to find their true interests out of a substantial number of potential candidates.

Personalized RSs play an important role in many online services. The task of personalized RS is to provide a ranked list of items for each individual user. Accurate personalized RSs can benefit users as well as content publishers and platform providers. RSs are utilized in a variety of commercial areas to provide personalized recommendations to users, including for example: providing video or music suggestions for streaming and download content provider platforms; providing product suggestions for online retailer platforms; providing application suggestions for app store platforms; providing content suggestions for social media platforms; and suggesting news articles for mobile news applications or online news websites.

RSs usually employ one or both of collaborative filtering (CF) and content-based filtering. Both of these filtering methodologies apply a personality-based approach that recommends personalized products or services for different users based on their historical behaviors.

CF methodologies typically build a predictive model or function that is based on a target or active user's past behavior (e.g., items previously purchased or selected and/or a numerical rating given to those items) as well on the past behavior of other users who have behavioral histories similar to that of the active user. By contrast, content-based filtering methodologies utilize a series of discrete, pre-tagged characteristics of an item (item attributes) in order to recommend additional items with similar properties. However, content-based filtering methodologies can be impeded by the fact that a large number of items have a very limited number of associated item attributes, due at least in part to the volume of items that are continually being added.

Some RSs integrate content-based filtering methodologies into CF methodologies to create a hybrid system. However, the lack of suitable item attributes for the exploding number of items that are available through online platforms requires most RSs to still heavily rely on only CF methods that give recommendations based on users' historical behaviors.

CF methodologies can typically be summarized as: Step 1) Look for users who share the same interaction patterns with the active user (the user whom the prediction is to be made); and Step 2) Use the ratings/interactions from those like-minded users found in step 1 to calculate a prediction for the active user. Finding users who share the same interaction patterns requires identification of similar users or similar items. The process of deriving similar users and similar items includes embedding each user and each item into a low-dimensional space created such that similar users are nearby and similar items are nearby. In this regard, an embedding is a mapping of discrete, categorical, variables to a vector of continuous numbers. In the context of neural networks, embeddings are low-dimensional, learned continuous vector representations of discrete variables. Embeddings in personalized RS are useful because they can meaningfully represent users and items in a transformed vector space as low-dimensional vectors.

Existing CF approaches attempt to generate representative and distinct embeddings for each user and item. Such representative embeddings can capture complex relations between users and items. The closer that an item and a user are in a vector space, the more likely that the user will interact with or rate the item highly.

A classic and successful method for CF is matrix factorization (MF). MF algorithms characterize both items and users by vectors in the same space, inferred from observed entries of user-item historical interaction. MF algorithms work by decomposing a user-item interaction matrix into the product of two lower dimensionality rectangular matrices with the goal of representing users and items in a lower dimensional latent space (also known as embedding representation in the context of deep learning algorithms). Early work in MF mainly applied the mathematical discipline of linear algebra of matrix decomposition, such as SVD (singular value decomposition) and its variants. In recent years, artificial neural network (ANN) and deep-learning (DL) techniques have been proposed, some of which generalize traditional MF algorithms via a non-linear neural architecture parameterized by neural networks and learnable weights. In the case of both linear algebra and DL-based MF models, the goal of MF is to find the right representation of each user and each item as vector representations.

In RS, various relationships exist that can be represented as graphs, such as social networks (user-user graph), commodity similarity (item-item graph), and user-item interaction (can be modeled as a user-item bipartite graph). Graph convolution neural networks (GCNNs) have demonstrated to be powerful tools for learning embeddings. GCNNs have been applied for recommendation by modeling the user-item interaction history as a bipartite graph. GCNNs are trained to learn user and item representations of user and item nodes in a graph structure and model user-item interaction history as connecting edges between the nodes. The vector representation of a node is learned by iteratively combining the embedding (i.e., mapping of a discrete variable to a vector of continuous numbers) of the node itself with the embeddings of the nodes in its local neighborhood. In the context of neural networks, embeddings are low-dimensional, learned continuous vector representations of discrete variables. Neural network embeddings are useful because they can reduce the dimensionality of categorical variables and meaningfully represent categories in the transformed space.

Most existing methods split the process of learning a vector representation (i.e., embedding) of a node (which can be an item node or a user node) into two steps: neighborhood aggregation, in which an aggregation function operates over sets of vectors to aggregate the embeddings of neighbors, and center-neighbor combination that combines the aggregated neighborhood vector with the central node embedding. GCNN-based CF models learn user and item node embeddings on graphs in a convolution manner by representing a node as a function of its surrounding neighborhood.

In some GCNN based bipartite graph RSs, the aggregation function operates over local neighborhoods of a central node (e.g., an item node or a user node), where a local neighborhood refers to the direct connection of that node in the given topology (graph). For example, the item nodes that interact with a central user node will form the local neighborhood of that user node. In the case of an ANN, the aggregation function can be implemented using an NN Multi-layer perception (MLP) that transforms the input using a learnable non-linear transformation function to learn weights on every single dimension of the input vector. The output of the MLP layer is the input vector weighted by neural network parameters, and these parameters will be updated by gradient descent of the neural network.

Existing GCNN based bipartite graph RSs treat observed graphs as a ground-truth depiction of relationships and thus treat the observed graph as very strong prior knowledge. However, because of data sparsity, the bipartite user-item interaction graphs are in fact often missing many edges, reflecting very limited information.

Learning on fixed and incomplete graphs omits all the potential preferences of users, and thus falls short in terms of diversity and efficacy in RS applications. This can lead to deterioration in recommendation performance when learning on graphs.

Existing RSs empirically take one fixed threshold value for choosing similar users and items, which is hard to generalize on different datasets. Also, existing RSs typically share one common threshold for all users and items which do not consider personalization. Furthermore, existing RSs typically adopt a two-step training procedure by first searching for the best threshold value followed by prediction model training. Such a method can lead to a sub-optimal RS.

Accordingly there is a need for a RS that is able compensate for data sparsity that is inherently present in an environment of rapidly expanding numbers of users and volume of content.

### SUMMARY

According to a first aspect of the present disclosure, there is provided a computer implemented method for a recommendation system (RS) for processing an input dataset that identifies a set of users, a set of items, and user-item interaction data about historic interactions between users in the set of users and items in the set of items. The computer implemented method includes generating, based on the user-item interaction data, a user-user similarity dataset that indicates user-user similarity scores for pairs of users in the set of users; generating, based on the user-item interaction data, an item-item similarity dataset that indicates item-item similarity scores for pairs of items in the set of items filtering the user-user similarity dataset based on a user similarity threshold vector to generate a filtered user-user similarity dataset, the user similarity threshold vector including a respective user similarity threshold value for each user in the set of users. The computer implemented also includes generating a set of user neighbour embeddings based on the filtered user-user similarity dataset and a set of user embeddings, the set of user embeddings including a respective user embedding for each user in the set of users; filtering the item-item similarity dataset based on an item similarity threshold vector to generate a filtered item-item similarity dataset, the item similarity threshold vector including a respective item similarity threshold value for each item in the set of items and generating a set of item neighbour embeddings based on the filtered item-item similarity dataset and a set of item embeddings, the set of item embeddings including a respective item embedding for each item in the set of items; generating a set of relevance scores based on the user neighbour embeddings and the item neighbour embeddings, the set of relevance scores including, for each user in set of users, respective relevance scores for the items in the set of items. The computer implemented method further includes generating a list of one or more recommended items for each user based on the set of relevance scores.

The use of personalized thresholds for each user and each item may, in some applications, enable more accurate personalized rankings to be generated by an RS. This may enable operation of an RS to be optimized such that a user is not presented with irrelevant or misleading item options. In least some aspects of the computer-implemented method of the present disclosure, optimization can improve RS efficiency as the consumption of one or more of computing resources, communications bandwidth and power may be reduced by not presenting users with irrelevant options and minimizing exploration of irrelevant options by users.

The computer implemented method may include learning the user similarity threshold vector, the set of user embeddings, the item similarity threshold vector, and the set of item embeddings.

Thus, in some aspects of the computer implemented method of the present disclosure, threshold vectors and embeddings are learned personally and adaptively for each user and item, which may improve system accuracy and enhance the advantages noted above.

Learning the user similarity threshold vector, the set of user embeddings, the item similarity threshold vector, and the set of item embeddings may include performing a bilevel optimization process that includes an inner optimization stage for learning the user embeddings and item embeddings based on a lower-level objective function and an outer optimization stage for learning the user similarity threshold vector and item similarity threshold vector based on an upper level objective function.

The computer implemented method may include performing the bilevel optimization process by computing proxy embeddings for the user embeddings and the item embeddings and using the proxy embeddings during the outer optimization stage.

The inner optimization stage for learning the user embeddings and item embeddings may include: (a) filtering the user-user similarity dataset based on an interim user similarity threshold vector to generate an interim filtered user-user similarity dataset; (b) filtering the item-item similarity dataset based on an interim item similarity threshold vector to generate an interim filtered item-item similarity dataset; (c) generating an interim set of user neighbour embeddings based on the interim filtered user-user similarity dataset and an interim set of user embeddings; (d) generating an interim set of item neighbour embeddings based on the interim filtered item-item similarity dataset and an interim set of item embeddings; (e) generating a set of interim relevance scores based on the interim user neighbour embeddings and the interim item neighbour embeddings; (f) determining a loss based on the generate a set of interim relevance scores; (g) updating the interim set of user embeddings and interim set item embeddings to minimize the loss; repeating (c to g) until the interim set of user embeddings and interim set of item embeddings are optimized in respect of the interim user similarity threshold vector and interim item threshold vector. The outer optimization stage for learning the user similarity threshold vector and the item similarity threshold vector may include: (h) filtering the user-user similarity dataset based on an interim user similarity threshold vector to generate an interim filtered user-user similarity dataset; (i) filtering the item-item similarity dataset based on an interim item similarity threshold vector to generate an interim filtered item-item similarity dataset; (j) generating an interim set of user neighbour embeddings based on the interim filtered user-user similarity dataset and a proxy set of user embeddings; (k) generating an interim set of item neighbour embeddings based on the interim filtered item-item similarity dataset and a proxy set of item embeddings; (l) generating a set of interim relevance scores based on the interim user neighbour embeddings and the interim item neighbour embeddings; (m) determining the loss based on the generate a set of interim relevance scores; (n) updating the interim user similarity threshold vector and interim item similarity threshold vector to minimize the loss; repeating (h to n) until the interim user similarity threshold vector and interim item similarity threshold vector are optimized in respect of the proxy set of user embeddings and the proxy set of item embeddings. The inner optimization stage and the outer optimization stage are successively repeated during a plurality of training iterations.

Learning the user similarity threshold vector, the set of user embeddings, the item similarity threshold vector, and the set of item embeddings may include determining a plurality of triplets based on the input dataset, wherein each triplet identifies: (i) a respective user from the set of users; (ii) a positive item from the set of items that is deemed to be positive with respect to the respective user based on the user-item interaction data; and (iii) a negative item from the set of items that is deemed to be negative with respect to the respective user based on the user-item interaction data; and learning the system parameters to optimize an objective that maximizes, for the plurality of triplets, a difference between relevance scores computed for positive items with respect to users and relevance scores computed for negative items with respect to users.

The user-user similarity scores for the pairs of users and the item-item similarity scores for the pairs of items may be determined using a cosine similarity algorithm.

Filtering the user-user similarity dataset may include, for each user: replicating in the filtered user-user similarity dataset any of the user-user similarity scores for the user from the user-user similarity dataset that exceed the respective user similarity threshold value for the user, and setting to zero in the filtered user-user similarity dataset any of the user-user similarity scores for the user from the user-user similarity dataset that do not exceed the respective user similarity threshold value for the user. Filtering the item-item similarity dataset comprises, for each item: replicating in the filtered item-item similarity dataset any of the item-item similarity scores for the item from the item-item similarity dataset that exceed the respective item similarity threshold value for the item, and setting to zero in the filtered item-item similarity dataset any of the item-item similarity scores for the item from the item-item similarity dataset that do not exceed the respective item similarity threshold value for the item.

Generating the set of user neighbour embeddings may include determining a dot product of a matrix representation of the filtered user-user similarity dataset and a matrix representation of the set of user embeddings; and generating the set of item neighbour embeddings comprises determining a dot product of a matrix representation of the filtered item-item similarity dataset and a matrix representation of the set of item embeddings.

Generating the set of relevance scores may include determining a dot product of a matrix representation of the set of user neighbour embeddings and a matrix representation of the set of item neighbour embeddings.

According to a further aspect of the present disclosure, there is provided a recommendation system for processing an input dataset that identifies a set of users, a set of items, and user-item interaction data about historic interactions between users in the set of users and items in the set of items. The recommendation system includes: a processing device; a non-transitory storage device coupled to the processing device and storing software instructions which, when executed by the processing device, cause the recommendation system to perform the following operations: generate, based on the user-item interaction data, a user-user similarity dataset that indicates user-user similarity scores for pairs of users in the set of users; generate, based on the user-item interaction data, an item-item similarity dataset that indicates item-item similarity scores for pairs of items in the set of items; filter the user-user similarity dataset based on a user similarity threshold vector to generate a filtered user-user similarity dataset, the user similarity threshold vector including a respective user similarity threshold value for each user in the set of users; generate a set of user neighbour embeddings based on the filtered user-user similarity dataset and a set of user embeddings, the set of user embeddings including a respective user embedding for each user in the set of users; filter the item-item similarity dataset based on an item similarity threshold vector to generate a filtered item-item similarity dataset, the item similarity threshold vector including a respective item similarity threshold value for each item in the set of items; generate a set of item neighbour embeddings based on the filtered item-item similarity dataset and a set of item embeddings, the set of item embeddings including a respective item embedding for each item in the set of items; generate a set of relevance scores based on the user neighbour embeddings and the item neighbour embeddings, the set of relevance scores including, for each user in set of users, respective relevance scores for the items in the set of items; and generate a list of one or more recommended items for each user based on the set of relevance scores.

The RS may be a GCNN based bipartite graph RS.

According to a further aspect of the present disclosure, there is provided a non-transitory computer-readable medium that stores software instructions which, when executed by a processing device, case the processing device to: receive an input dataset that identifies a set of users, a set of items, and user-item interaction data about historic interactions between users in the set of users and items in the set of items; generate, based on the user-item interaction data, a user-user similarity dataset that indicates user-user similarity scores for pairs of users in the set of users; generate, based on the user-item interaction data, an item-item similarity dataset that indicates item-item similarity scores for pairs of items in the set of items; filter the user-user similarity dataset based on a user similarity threshold vector to generate a filtered user-user similarity dataset, the user similarity threshold vector including a respective user similarity threshold value for each user in the set of users; generate a set of user neighbour embeddings based on the filtered user-user similarity dataset and a set of user embeddings, the set of user embeddings including a respective user embedding for each user in the set of users; filter the item-item similarity dataset based on an item similarity threshold vector to generate a filtered item-item similarity dataset, the item similarity threshold vector including a respective item similarity threshold value for each item in the set of items; generate a set of item neighbour embeddings based on the filtered item-item similarity dataset and a set of item embeddings, the set of item embeddings including a respective item embedding for each item in the set of items; generate a set of relevance scores based on the user neighbour embeddings and the item neighbour embeddings, the set of relevance scores including, for each user in set of users, respective relevance scores for the items in the set of items; and generate a list of one or more recommended items for each user based on the set of relevance scores.

### BRIEF DESCRIPTION OF THE DRAWINGS

Reference will now be made, by way of example, to the accompanying drawings which show example embodiments of the present application, and in which:

FIG. 1 is a block diagram illustrating an example of a bipartite graph;

FIG. 2 is a block diagram illustrating a recommendation system according to example embodiments;

FIG. 3 is a block diagram illustrating examples of a User-Item (U-I) interaction matrix, User-User (U-U) similarity matrix and Item-Item (I-I) similarity matrix according to example embodiments;

FIG. 4 is a block diagram illustrating personalized filtering of an I-I interaction matrix to generate a directed I-I graph;

FIG. 5 is illustrates adaptive generation of a directed I-I graph over a plurality of training sessions;

FIG. 6 is a pseudocode representation of training process for the RS of FIG. 2;

FIG. 7 is a flowchart showing actions performed by the RS of FIG. 2 according to an example embodiment; and

FIG. 8 is a block diagram illustrating an example processing system that may be used to execute machine readable instructions to implement the RS of FIG. 2.

Similar reference numerals may have been used in different figures to denote similar components.

### DESCRIPTION OF EXAMPLE EMBODIMENTS

According to example embodiments, bilevel optimization is incorporated into a machine learning (ML) based recommendation system (RS). In particular, instead of using an RS training procedure in which neighborhood threshold values are first determined and then used as a hyper parameter for generating item and user node embeddings, bilevel optimization is used to collectively and adaptively learn both item neighborhood threshold values and node embeddings during an end-to-end training process

Bilevel optimization can be considered as an optimization problem that contains another optimization problem as a constraint, for example an outer optimization task (commonly referred to as the upper-level optimization task), and an inner optimization task (commonly referred to as the lower-level optimization task). Bilevel optimization can be implemented using a computer program to model hierarchical decision processes and engineering design problems. A simple form of the bilevel optimization problem is defined below:

$${min}_{x ∈ X , y} F ( x , y ) \\ \text{s.t.} G ( x , y ) \leq 0 \\ {min}_{y} f ( x , y ) \\ \text{s.t.} g ( x , y ) \leq 0 ,$$

Where x and [symbol] are a set of upper-level variables and lower-level variables respectively. Similarly, the functions F and f are upper-level and lower-level objective functions respectively, while the vector-valued functions G and g are called the upper-level and lower-level constraints respectively. Upper-level constraints G involve variables from both levels and play a very specific role. The application of bilevel optimization in a RS will be discussed in greater detail below.

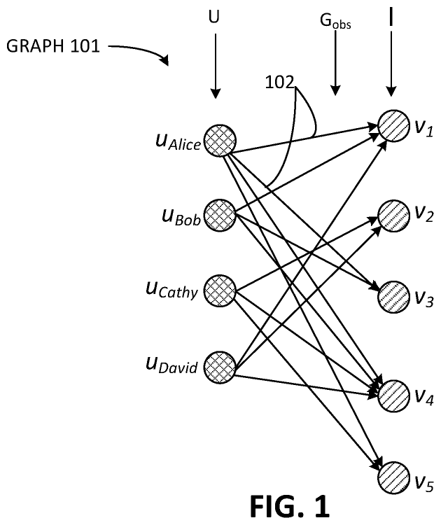

As known in the art, a graph is a data structure that comprises nodes and edges. Each node represents an instance or data point. Each edge represents a relationship that connects two nodes. A bipartite graph is a form of graph structure in which each node belongs to one of two different node types and direct relationships (e.g., 1-hop neighbors) only exist between nodes of different types. FIG. 1 illustrates a simplified representation of a sample of an observed bipartite graph 101 that includes two types of nodes, namely user type nodes (referred to herein as “user nodes) that represent users u_{Alice} to u_{David} (collectively user set U, representing a set of nᵤₛₑᵣₛ=4 users) and item type nodes (referred to herein as item nodes) that represent items v₁ to v₅ (collectively item set I, representing a set of nᵢₜₑₘₛ=5). In the present disclosure, “u” is used to refer to a generic user or users and “v” is used to refer to a generic item or items. Each respective user node represents an instance of a user u. For example, user u_{Alice}, who may for example be the user associated with a specific registered user account or unique user identifier, is represented in graph 101 by the user node denoted as u_{Alice}. Each respective item node represents an instance of a unique item v. For example item v₁, which may for example be the movie “No Time To Die” may be represented in graph 101 by the item node denoted as v₁. Items may for example be products or services that are available to a user. For example, in various scenarios, items may be: audio/video media items (such as a movie or series or video) that a user can stream or download from an online video content provider; audio media items (such as a song or a podcast) that a user can stream or download from an online audio content provider; image/text media items (such as new articles, magazine articles or advertisements) that a user can be provided with by an online content provider; software applications (e.g., online apps) that a user can download or access from an online software provider such as an app store; and different physical products (e.g., toys, prepared meals, clothing, etc.,) that a user can order for delivery or pickup from an online retailer. The examples of possible categories of items provided above is illustrative and not exhaustive.

In example embodiments, users u_{Alice} to u_{David} and items v₁ to v₅ are represented in graph 101 as unattributed user nodes and item nodes respectively, meaning that each node has a type (item or user) and a unique identity (e.g., identity is indicated by the subscripts of v₁ and u_{Alice}), but no additional known attributes. In some examples, item identity could map to a specific class of item (e.g., movie). In alternative embodiments, the nodes may each be further defined by a respective set of node features (e.g., age, gender, geographic location, etc. in the case of a user, and genre, year of production, actors, movie distributer, etc. in the case of an item that is a movie).

The edges 102 that connect user nodes u to respective item nodes v indicate relationships between the nodes and collectively the edges 102 define the observed graph topology G_{obs}. For example, the presence or absence of an edge 102 between nodes represents the existence or absence of a predefined type of interaction between the user represented by the user node and the item represented by the item node. For example, the presence or absence of an edge 102 can indicate an interaction history such as whether or not a user u has previously selected the item v item for consumption (e.g., purchase, order, download, or stream an item), or submitted a scaled (e.g., 1 to 5 star) or binary (e.g. “like”) rating in respect of the item v, or interacted with the item v in some other trackable manner.

In some examples embodiments, edges 102 convey binary relationship information such that the presence of an edge indicates the presence of a positive interaction (e.g. user u_{alice} has previously “clicked” or rated/liked or consumed an item v₁) and the absence of an edge indicates an absence of a positive interaction (e.g., the lack of edge between user node representing user u_{Alice} and the item node representing item v₂ indicating that user u_{alice} has never interacted with particular item v₂, such that item v₂ is a negative item with respect to user u_{alice}. In some embodiments, edges 102 may be associated with further attributes that indicate a relationship strength (for example a number of “clicks” by a user in respect of a specific item, or the level of a rating given by a user).

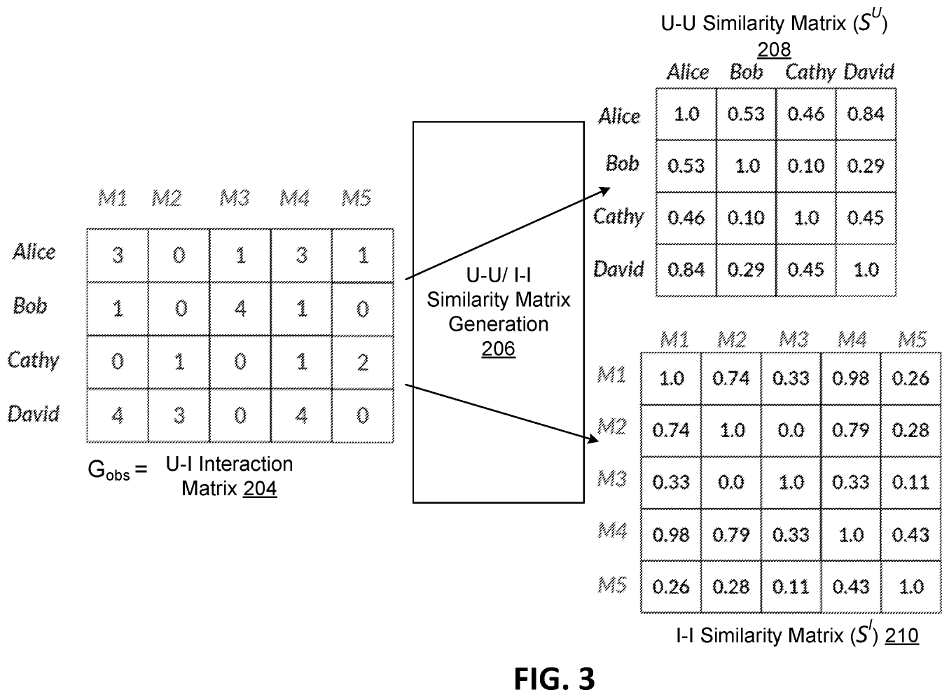

Thus, bipartite graph 101 includes information about users (e.g., user node set U), information about items (e.g., item node set V) and information about the historical interactions between users and items (e.g. graph topology G_{obs}, which can be represented as U-I interaction matrix 204 (FIG. 3)). In this regard, bipartite graph 101 represents a specific U-I interaction dataset.

In many real-life cases, the information present in an observed bipartite graph 101 has inherent data sparsity problems in that the historical interaction data present in graph 101 will often be quite limited, especially in the case of new users and items that have few interaction records. Thus, many user nodes and many item nodes may have very few connecting edges.

Accordingly, as will be described in greater detail below, example embodiments are described that may in some applications address one or more of the issues noted above that confront existing RSs.

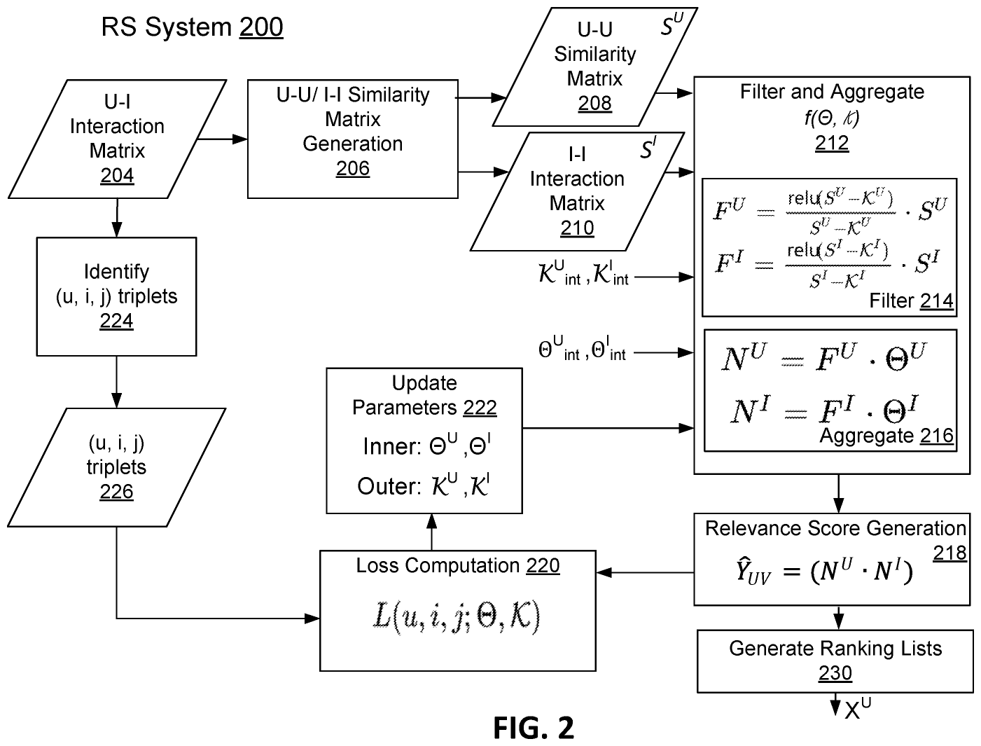

In this regard, FIG. 2 is a block diagram of a computer implemented RS 200. As will be described in detail below, RS 200 is configured to learn a plurality of parameters in respect of an input U-I interaction dataset, and then predict personalized item rankings for users based on the learned parameters. RS 200 includes a plurality of modules (for example, modules represented by blocks labeled 206, 212, 218, 220, 222 and 230 in FIG. 2) that enable the system to perform as described. As used herein, a “module” can refer to a combination of a hardware processing circuit and machine-readable instructions (software and/or firmware) executable on the hardware processing circuit for performing a given operation. A hardware processing circuit can include any or some combination of a central processing unit, a hardware accelerator, a tensor processing unit, a neural processing unit, a microprocessor, a core of a multi-core microprocessor, a microcontroller, a programmable integrated circuit, a field programmable gate array, a digital signal processor, or another hardware processing circuit. In some examples, a “module” can refer to a hardware processing circuit that is specifically configured to perform a given operation.

Although the RS 200 shown in FIG. 2 includes “modules”, it will be appreciated that in other embodiments, the RS may performs various operations to learn a plurality of parameters in respect of an input U-I interaction dataset, and then predict personalized item rankings for users based on the learned parameters. As used herein, an “operation” can refer to a task or function performed by machine-readable instructions (software and/or firmware) when executed by a hardware processing circuit.

The U-I interaction dataset represented by bipartite graph 101 can be provided as input to RS 200 in the form of a nᵤₛₑᵣ×nᵢₜₑₘ, user-item (U-I) interaction matrix 204 (FIG. 3). FIG. 3 illustrates a U-I interaction matrix 204 representation of the U-I interaction dataset of bipartite graph 101. U-I interaction matrix 204 defines a matrix of values that indicate the presence or absence of a connecting edge between each user node u and each item node v. In some examples, U-I interaction matrix 104 corresponds to a binary matrix (e.g., user has (“1”) or has not (“0”) interacted with an item), and in some alternative examples U-I interaction matrix 104 can correspond to a weighted matrix (e.g. user has rated an item on a discrete scale (“1” to “5”) or has not interacted with an item (“0”).

As indicated in FIGS. 2 and 3, RS 200 includes a similarity matrix generation module 206 for generating an nᵤₛₑᵣ×nᵤₛₑᵣ User-User (U-U) similarity matrix (S^{U}) 208 and an nᵢₜₑₘ×nᵢₜₑₘ Item-Item (I-I) similarity matrix (S^{I}) 210 in respect of U-I interaction matrix 204. In User-User (U-U) similarity matrix (S^{U}) 208, the row corresponding to a user u includes a vector of respective similarity scores that each indicate a respective similarity between the user u and each of the users included in user set U. In example embodiments the similarity scores are normalized values between 0 and 1, with 1 indicating greatest similarity. In Item-Item (I-I) similarity matrix (S^{I}) 210, the row corresponding to an item v includes a vector of respective similarity scores that each indicate a respective similarity between the item v and each of the items included in item set I. In example embodiments, similarity matrix generation module 206 is configured to determine similarity scores for user pairs based on the number of common items that each user in the pair has interacted with. Similarity matrix generation module 206 is configured to determine similarity scores for item pairs based on the number of common users that each item in the pair has interacted with. Although different methods can be used to determine similarity scores, in an illustrated example, similarity matrix generation module 206 applies a cosine similarity algorithm to generate U-U similarity matrix (S^{U}) 208 and I-I similarity matrix (S^{I}) 210, and the similarity scores computed for user pairs and item pairs are cosine similarity scores. In the illustrated example, each of the similarity scores is normalized within a range of 0 to 1, with 1 indicating greatest similarity.

Referring to FIG. 2, RS 200 includes a trainable filter and aggregate module 212 that is configured to: (i) apply a filtering operation 214 to filter both the U-U similarity matrix (S^{U}) 208 and I-I similarity matrix (S^{I}) 210 by applying a filtering operation 214 to generate respective directed graphs; and (ii) apply an aggregation operation 216 to the directed graphs to generate a neighborhood embedding n_u for each user u and a neighborhood embedding n_v for each item v.

Filtering operation 214 is configured to filter user-user pairs from U-U similarity matrix (S^{U}) 208 and item-item pairs from I-I similarity matrix (S^{I}) 210 that fall below threshold values. Filtering of U-U similarity matrix (S^{U}) 208 results in a filtered U-U similarity dataset F^{U}, as represented by the function:

$${F}^{U} = \frac{relu ( {S}^{U} - {𝒦}^{U} )}{{S}^{U} - {𝒦}^{U}} \cdot {S}^{U} \qquad ( Eq . 1 )$$

In Equation 1, S^{U} is the matrix of cosine similarity scores included in U-U similarity matrix (S^{U}) 208, and [symbol] ^{U} is a personalized threshold vector that includes nᵤₛₑᵣ threshold values (i.e. a personalized threshold value for each respective user u).

Similarly, filtering of I-I similarity matrix (S^{I}) 210 results in a filtered I-I similarity dataset F^{I}, as represented by the function:

$${F}^{I} = \frac{relu ( {S}^{I} - {𝒦}^{I} )}{{S}^{I} - {𝒦}^{I}} \cdot {S}^{I} \qquad ( Eq . 2 )$$

In Equation 2, S^{I} is the matrix of cosine similarity scores included in I-I similarity matrix (S^{I}) 210, and [symbol] ^{I} is a personalized threshold vector that includes nᵢₜₑₘ threshold values (i.e. a personalized threshold value for each respective item v).

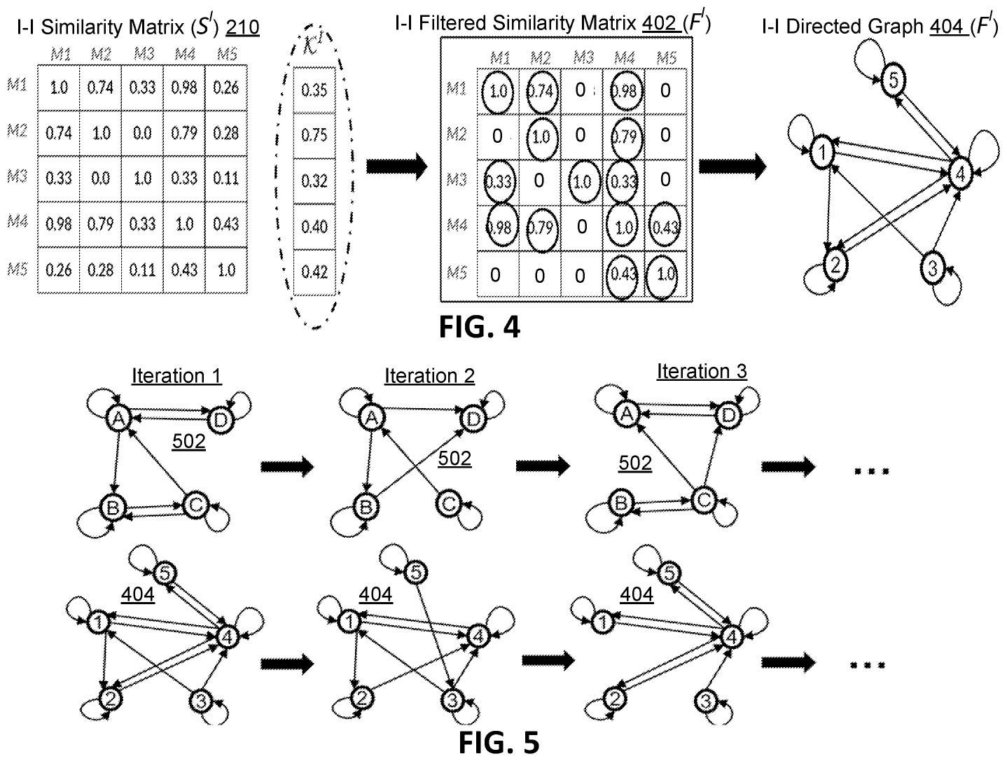

FIG. 4 illustrates an example of the operation of Filtering operation 214 that applies threshold vector [symbol] ^{I} to I-I similarity matrix (S^{I}) 210 to generate I-I Filtered Similarity dataset F^{I}, which can be represented as I-I Filtered Similarity Matrix 402 of size nᵢₜₑₘ×nᵢₜₑₘ. As indicated by Equation 2, each of the similarity scores in I-I similarity matrix (S^{I}) 210 that exceeds a personalized row-specific threshold value k specified in threshold vector [symbol] ^{I} will be replicated in I-I Filtered Similarity Matrix 402, and each of the elements in I-I similarity matrix (S^{I}) 210 that is equal to or less than a personalized row-specific threshold value k specified in threshold vector [symbol] ^{I} will be set to a null or “0” value in I-I Filtered Similarity Matrix 402.

For example, in FIG. 4 the similarity scores in the first row, corresponding to item M1, are: 1.0 for item pair M1,M1; 0.74 for item pair M1,M2; 0.33 for item pair M1,M3; 0.98 for item pair M1,M4; and 0.26 for item pair M1,M5. The personalized threshold value specified in threshold vector [symbol] ^{I} for item M1 is k=0.35. The similarity scores in row M1 of I-I similarity matrix (S^{I}) 210 that are greater than the row specific threshold of k=0.35 (e.g. M1,M1=1.0; M1,M2=0.74 and M1,M4=0.98) are included in identical locations in row M1 of I-I Filtered Similarity Matrix 402, and the similarity scores in row M1 of I-I similarity matrix (S^{I}) 210 that are equal to or less than the row specific threshold of k=0.35 (e.g. M1,M3=0.33; M1,M5=0.26) are set to “0” in row M1 of I-I Filtered Similarity Matrix 402. In the case of row M2, the personalized row wise filter threshold is k=0.75, such that the similarity scores in row M2 of I-I similarity matrix (S^{I}) 210 that are greater than the row specific threshold of k=0.75 (e.g. M2,M2=1.0; M2,M4=0.79) are included in identical locations row M2 of in I-I Filtered Similarity Matrix 402, and the similarity scores in row M2 of I-I similarity matrix (S^{I}) 210 that are equal to or less than the row specific threshold of k=0.75 (e.g. M2,M1=0.74; M2,M3=0.0; and M2,M5=0.28) are set to “0” in row M2 of I-I Filtered Similarity Matrix 402.

Among other things, the use of personalized thresholds for each item enables the resulting filtered similarity data to be directional, meaning that although a first item, second item pair the similarity threshold for can be different for the first item with respect to the second item then for the second item with respect to the first item. For example, the pair similarity score for the first item, second item pair may meet the first item similarity threshold k, but the same pair similarity score may fail to meet the second item similarity threshold. An example of this directionality is illustrated in FIG. 4 in the case of item pair that includes items M1 and M2, for which the similarity score is 0.74. When filtering item M2 with respect to item M1 (e.g., denoted as item pair M1, M2) the threshold value is k=0.35; however for filtering item M1 with respect to item M2 (e.g., denoted as item pair M2, M1), the threshold value is k=0.74. Accordingly the similarity score 0.74 for item pair M1, M2 exceeds the item M1 threshold value of k=0.35 and is included in I-I Filtered Similarity Matrix 402, however the similarity score 0.74 for item pair M2, M1 is less than the item M2 threshold value of k=0.75 and is thus set to “0” in I-I Filtered Similarity Matrix 402.

The filtered I-I similarity dataset F^{I} that is included in I-I Filtered Similarity Matrix 402 can also be represented as an I-I directed graph 404 as shown in FIG. 4. In a similar manner, filtering operation 214 applies threshold vector [symbol] to U-U similarity matrix (S^{U}) 208 to generate a respective filtered I-I similarity dataset F^{U} (which can also be represented as nᵤₛₑᵣ×nᵤₛₑᵣ U-U Filtered Similarity Matrix and U-U directed graph.)

As will be explained in greater detail below, threshold vectors [symbol] and [symbol] (collectively denoted as threshold vector [symbol] ∈ [symbol] ^{|U|+|I|}) are adaptively learned over a set of training iterations during a training phase, such that a respective, unique filtering threshold value k is learned for each user u and item v. Prior to training, initialized threshold vectors [symbol] ᵢₙₜ, [symbol] ᵢₙₜ can be generated by random sampling from a range or pre-defined distribution of candidate threshold values.

FIG. 5 graphically illustrates the adaptation of a U-U directed graph 502 that is generated by filtering operation 214 in respect of U-U similarity matrix (S^{U}) 208, and the adaptation of I-I directed graph 404 that is generated by filtering operation 214 in respect of I-I similarity matrix (S^{I}) 210, over a set of successive training iterations during a training phase.

Filtering of U-U pairs and I-I pairs has previously been performed by using a single threshold value for all users and a single threshold value for all items. The use of personalized thresholds that are learned respectively for each user and each item may, in some applications, enable more accurate personalized rankings to be generated by a RS. This may enable operation of a RS to be optimized such that a user is not presented with irrelevant or misleading item options. In least some examples, optimization of operation of a RS can improve efficiency of the RS as the consumption of one or more of computing resources, communications bandwidth and power may be reduced by not presenting users with irrelevant options and minimizing exploration of irrelevant options by users.

Referring again to FIG. 2, the filtered U-U similarity dataset N^{U} and the filtered I-I similarity dataset N^{I} are each then subjected to aggregate operation 216. Aggregate operation 216 is configured to generate a neighbor embedding n_u for each user u and neighbor embedding n_v for each item v. In example embodiments, generation of neighbor embeddings N^{U} for users U can be represented by the function:

N^{U}=F^{U}·Θ^{U} (Eq. 3)

In Equation 3, Θ^{U} ∈ R^{|U|×d} is a set of user embeddings that are learned during iterative training of RS 200, and d is the dimensionality of each embedding.

Accordingly, in example embodiments, the neighbor embeddings N^{U} is a matrix that is the dot product of the filtered U-U similarity dataset F^{U} and the user embeddings Θ^{U}.

In example embodiments, generation of neighbor embeddings N^{V} for items V can be represented by the function:

N^{I}=F^{I}·Θ^{I} (Eq. 4)

In Equation 4, Θ^{I} ∈ R^{|I|×d} is a set of item embeddings that are learned during iterative training of RS 200.

Accordingly, in example embodiments, the neighbor embeddings N^{I} is a matrix that is the dot product of the filtered I-I similarity dataset F^{I} and the item embeddings Θ^{I}.

As will be explained in greater detail below, the sets of personalized user embeddings Θ^{U} and item embeddings Θ^{I} (collectively denoted as model embeddings Θ ∈ R^{(|U|+|I|)×d)}) are adaptively learned over a set of training iterations performed during a training phase, such that a respective, unique embedding is learned for each user u and item v. Prior to performing the set of training iterations during the training phase, initialized user embeddings Θᵢₙᵢₜ^{U} and item embeddings Θᵢₙᵢₜ^{I} can be generated by random sampling from a range or pre-defined distribution of candidate embedding values.

Thus, the function performed by filter and aggregate module 212 in respect of each of the U-U similarity matrix (S^{U}) 208 and I-I similarity matrix (S^{I}) 210 can be represented by the equation:

$$f ( Θ , 𝒦 ) = \frac{relu ( S - 𝒦 )}{S - 𝒦} \cdot S \cdot Θ \qquad ( Eq . 5 )$$

In example embodiments, a relevance score generation module 218 is configured to generate a respective relevance score ŷ_{UV} for each item-user pair included in the input U-I interaction matrix. In example embodiments, a U-I relevance score matrix Ŷ_{UV} can be generated as a dot product of the filtered U-U similarity matrix user dataset N^{U} and filtered I-I similarity matrix user dataset N^{I} as using a function:

Ŷ_{UV}=(N^{U}·N^{I}) (Eq. 6)

In Equation 6, each user-item relevance score ŷᵤᵥ indicates a relevance score for a respective item v with respect to a respective user u.

As will be explained in greater detail below, the training phase of RS 200 is performed until the system parameters (in particular, model embeddings Θ and threshold vector [symbol] ) have been adaptively learned to optimize a defined objective. When the training phase is complete and the defined objective optimized, a final set Ŷ_{UV} of relevance scores are generated by relevance score generation module 218 during an inference phase, and this final set of final set Ŷ_{UV} of relevance scores can be used by a generate ranking lists module 230 to generate a personalized recommendation list xᵤᵥ of items that are most relevant for each individual user u. In some examples, the inference phase may be a final iteration of the training phase.

Training of RS 200 will now be described in greater detail according to examples embodiments. In example embodiments, a bilevel optimization objective, adapted from the Bayesian Personalized Ranking (BPR) loss), is used to train RS 200. In particular, values for the system parameters, namely model embeddings Θ and threshold vector K, are learned to optimize a training objective. In example embodiments, the training objective is a bilevel optimization objective, with the model embeddings Θ being learned during a model embeddings update phase to optimize an inner or lower level optimization task and the threshold vector K being learned during a threshold vector update stage to optimize an outer or higher level training task. In this regard, the recommendation task that is performed by RS 200 is treated as a ranking problem in which the input is user implicit feedback and the output is an ordered set of recommended items Xᵤ with respect to each user u.

Referring to FIG. 2, for training purposes the RS 200 includes a triplet identification module 224 for identifying a list of ground truth (u, i, j) triplets 226 from the U-I interaction matrix 204, where “i” denotes an item v that is a positive item with respect to user u and “j” denotes an item v that is a negative item with respect to user u. In example embodiments, the relationships between items and users can be classified as positive or negative based on the interaction history between such items. For example, in the case the U-I interaction dataset that is represented by U-I graph 101 and corresponding U-I interaction matrix 204, the presence of an edge between a user node representing user u_{Alice} and an item node representing item M1 can indicate that the item M1 is a positive item with respect to the user u_{Alice}, and the absence of an edge between the user node representing u_{Alice} and the item node representing item M2 can indicate that the item M2 is a negative item with respect to the user u_{Alice}. Accordingly, each ground truth (u, i, j) triplet identifies a user-item pair u,i where i is a positive item with respect to user u, and a further user-item pair u,j for the same where a further item j is a negative item with respect to the same user u. In example embodiments, this indicates that based on the information include in the input U-I interaction dataset (e.g., U-I interaction matrix) 204, the user u identified in (u, i, j) triplet is assumed to prefer item i over item j. The identified (u,i,j) triplets are provided to a loss computation module 220.

During training, the relevance scores ŷᵤᵥ generated by relevance score generation module 218 can be separated, based on user and item identity, by the loss computation module 220, into relevance scores ŷᵤᵢ that correspond to user-item pairs in which the item is positive with respect to the user and relevance scores ŷᵤⱼ that correspond to user-item pairs in which the item is negative with respect to the user. During the training phase, the objective is joint optimization objective to learn system parameters (model embeddings Θ and threshold vector [symbol] ) that will maximize the difference between the relevance scores ŷᵤᵢ and ŷᵤⱼ that correspond to the user, positive item and negative item identified in a ground truth (u, i, j) triplet.

In this regard, a joint optimization objective can be represented as:

$${Θ}^{*} , {𝒦}^{*} = {arg min}_{Θ , 𝒦} {\sum }_{u} {\sum }_{i ϵ {D}_{u}} {\sum }_{j ∉ {D}_{u}} L ( u , i , j ; Θ , 𝒦 ) \qquad ( Eq . 7 )$$

With the loss L in Equation 7 being denoted as:

L(u, i, j; Θ, [symbol] )=−ln(σ(ŷᵤᵢ(f(Θ, [symbol] ))−ŷᵤⱼ(f(Θ, [symbol] ))+Ω(Θ) (Eq. 8)

In Equation 8, Ω(·) is a regularization term.

The joint optimization objective of Equation 7 can be difficult to achieve as the threshold values in threshold vector [symbol] can be very small (or zero), and no clear constraints or guidance is provided for determining threshold vector [symbol] , which can result in long searching times and difficulty converging. To address this issue, in example embodiments the joint optimization is treated as a bilevel optimization problem where the threshold vector [symbol] is a set of upper-level (e.g., outer) variables and the model embeddings Θ and is a set of lower-level (e.g., inner) variables. The upper level and lower level objective functions can be respectively represented as:

$${min}_{𝒦} {𝒥}_{outer} ( {Θ}^{*} ( 𝒦 ) , 𝒦 ) := {\sum }_{u} {\sum }_{i ϵ {D}_{u}} {\sum }_{j ∉ {D}_{u}} L ( u , i , j ; {Θ}^{*} ( 𝒦 ) , 𝒦 ) \\ \text{s.t.} {Θ}^{*} ( 𝒦 ) = {arg min}_{Θ} {𝒥}_{inner} ( Θ , 𝒦 ) := {\sum }_{u} {\sum }_{i ϵ {D}_{u}} {\sum }_{j ∉ {D}_{u}} L ( u , i , j ; Θ , 𝒦 ) \qquad ( Eq . 9 )$$

Where:
u: user
i: positive item w.r.t. u
j: negative item w.r.t u
Dᵤ: training dataset w.r.t. u
Θ ∈ [symbol] ^{(|U|+|I|)×d}: model embeddings
[symbol] ∈ [symbol] ^{|U|+|I|}: personalized threshold

As indicated in FIG. 2, loss computation module 220 implements the operations required to compute the loss represented in Equation 8. The computed loss is used by an update parameters operation 222 which performs backpropagation to compute gradients that are used to update the system parameters as part of gradient descent based training of the filter and aggregate function 212, during which filter and aggregate module 212 is trained to learn an optimized set of system parameters (model embeddings Θ and threshold vector [symbol] ). The model embeddings are updates based on the inner level loss, at time t, and the threshold vectors are updated based on the outer level loss, at time t+1. As represented in Equation 8, the losses are based on the difference between the relevance scores ŷᵤᵢ and ŷᵤⱼ that correspond to the user, positive item and negative item identified in a ground truth (u, i, j) triplet.

Accordingly, during the training stage for RS 200, the system parameters are learned through a two stage interactive training process. In particular, inner optimization/model embedding Θ update stage is performed during which the threshold vector [symbol] is fixed and model embeddings Θ are updated using gradient descent. An outer optimization/threshold vector [symbol] update stage is then performed, during which the model embeddings Θ are fixed and threshold vector [symbol] is updated using gradient descent. The inner and outer update stages can be iteratively repeated until convergence is achieved. As noted above, in the case of bilevel optimization the outer optimization constraints must be enforced indirectly. Accordingly, in example embodiments by using a proxy function to generate a connection between the gradient on threshold vector [symbol] with the outer objective. The proxy function is defined below:

\tilde{Θ}^{t+1}:=Θ^{t}−α∇_{Θ}_{^{t}} [symbol] ᵢₙₙₑᵣ(Θ^{t}, [symbol] ^{t}) (Eq. 9)

The proxy model embeddings \tilde{Θ}ⁱ⁺¹ are the model embeddings Θ^{t} from the previous training iteration adjusted by the gradient descent value determined by the current training iteration as scaled by a hyperparameter scaling value α.

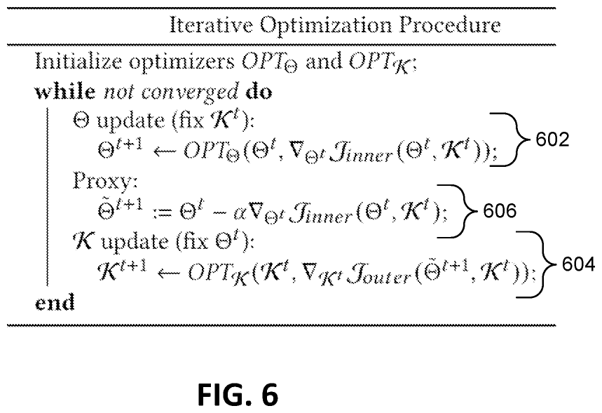

A pseudocode representation of bilevel optimization process for training RS 200 to learn optimized system parameters for the filter and aggregate function 212 is represented in FIG. 6. Reference 602 indicates pseudocode for inner optimization/model embedding Θ update stage, during which the threshold vector [symbol] is fixed and model embeddings Θ are updated during a first time-step t according to an inner-level objective function. Reference 604 indicates pseudocode for outer optimization/threshold vector [symbol] update stage, during which the model embeddings Θ are fixed and threshold vector [symbol] is updated using gradient descent during a subsequent time-step t+1 according to an outer-level objective function. Reference 606 illustrates a proxy function that is used to generate a connection between threshold vector [symbol] with the outer objective. When compared to existing RSs which implement a model that is trained in a two-step procedure (e.g., first search for the optimal threshold value, then train the model to learn the model embeddings), in the example embodiments of the present disclosure end-to end training is achieved by using bilevel optimization to learn both the model embeddings and the personalized threshold vector. Adaptive learning of the personalized values in threshold vector [symbol] can in some applications enable more accurate learning by useful information during neighborhood aggregation, thus improving the recommendation quality. Treating the threshold vector [symbol] as a learnable system parameter can provide more useful threshold values. Furthermore, as model embeddings Θ and threshold vector [symbol] are iteratively learned during the training process, guidance can be provided to the gradient descent of the threshold vector [symbol] , which can save time and computing resources when compared to a pure Bayesian search algorithm.

The present disclosure provides a novel bilevel optimization framework to achieve personalized neighborhood selection in recommendation systems such as RS 200. The similarity threshold values include in threshold vector [symbol] are treated as learnable system parameters which will be learned in an end-to-end way, rather than a hyper parameter as in existing RSs. Further, instead of searching for a global optimal threshold value by using Bayesian search algorithms as is done in existing RSs, the disclosed solution uses bilevel optimization to jointly learn the item and user embeddings and the threshold vector adaptively during the training phase. The threshold values are not fixed and shared for all users and items, but rather a personalized threshold value is learned for each individual user and item for choosing neighbors.

In example embodiments, the filter and aggregate module 212, including filter operation 214 and aggregate operation 216, can be embedded into a variety of different ML models. For example, personalized RSs commonly use deep learning/graphic neural network models that are configured to learn user and item embeddings as the ultimate goal. Accordingly, one or more of the operations of filter and aggregate module 212 and relevance score generation module 218 may be embedded in a GNN model.

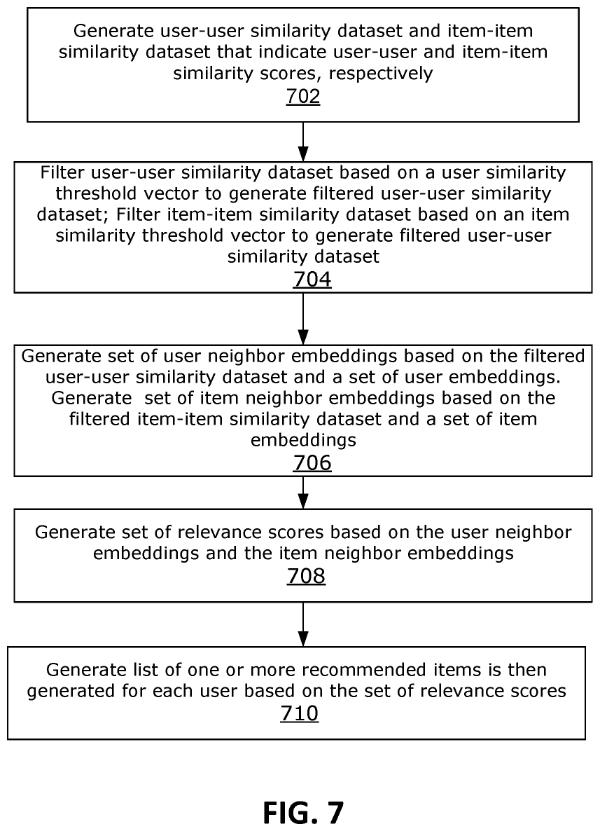

FIG. 7 is flow chart illustrating operations of RS 200. As noted above, the input dataset to the RS 200 is a U-I interaction matrix that identifies a set of users U, a set of items I, and user-item interaction data about historic interactions between users u in the set of users U and items v in the set of items I. As indicated at block 702, based on the user-item interaction data, a user-user similarity dataset is generated that indicates user-user similarity scores for pairs of users in the set of users, and based on the user-item interaction data, an item-item similarity dataset is generated that indicates item-item similarity scores for pairs of items in the set of items.

During an inference phase, the following operations are performed to process the user-user and item-item similarity data:

As indicated at block 704, the user-user similarity dataset is filtered based on a user similarity threshold vector to generate a filtered user-user similarity dataset, and the item-item similarity dataset is filtered based on an item similarity threshold vector to generate a filtered item-item similarity dataset. The user similarity threshold vector includes a respective user similarity threshold value for each user in the set of users, and the item similarity threshold vector includes a respective item similarity threshold value for each item in the set of items.

As indicated at block 706, a set of user neighbor embeddings is generated based on the filtered user-user similarity dataset and a set of user embeddings, the set of user embeddings including a respective user embedding for each user in the set of users. Similarly, a set of item neighbor embeddings is generated based on the filtered item-item similarity dataset and a set of item embeddings, the set of item embeddings including a respective item embedding for each item in the set of items.

As indicated at block 708, a set of relevance scores is generated based on the user neighbor embeddings and the item neighbor embeddings, the set of relevance scores including, for each user in set of users, respective relevance scores for the items in the set of items.

As indicated at block 710, a list of one or more recommended items is then generated for each user based on the set of relevance scores.

In example embodiments, the user similarity threshold vector, the set of user embeddings, the item similarity threshold vector, and the set of item embeddings collectively comprise system parameters that are learned during a training phase that precedes the inference phase. As described above, during the training phase a bilevel optimization process is performed that includes an inner optimization stage for learning the user embeddings and item embeddings based on a lower-level objective function and an outer optimization stage for learning the user similarity threshold vector and item similarity threshold vector based on an upper level objective function.

In example embodiments, the inner optimization stage for learning the user embeddings and item embeddings includes: (a) filtering the user-user similarity dataset based on an interim user similarity threshold vector to generate an interim filtered user-user similarity dataset; (b) filtering the item-item similarity dataset based on an interim item similarity threshold vector to generate an interim filtered item-item similarity dataset; (c) generating an interim set of user neighbor embeddings based on the interim filtered user-user similarity dataset and an interim set of user embeddings; (d) generating an interim set of item neighbor embeddings based on the interim filtered item-item similarity dataset and an interim set of item embeddings; (e) generating a set of interim relevance scores based on the interim user neighbor embeddings and the interim item neighbor embeddings; (f) determining a loss based on the generate a set of interim relevance scores; (g) updating the interim set of user embeddings and interim set item embeddings to minimize the loss; repeating (c to g) until the interim set of user embeddings and interim set of item embeddings are optimized in respect of the interim user similarity threshold vector and interim item threshold vector.

In example embodiments, the outer optimization stage for learning the user similarity threshold vector and the item similarity threshold vector includes: (h) filtering the user-user similarity dataset based on an interim user similarity threshold vector to generate an interim filtered user-user similarity dataset; (i) filtering the item-item similarity dataset based on an interim item similarity threshold vector to generate an interim filtered item-item similarity dataset; (j) generating an interim set of user neighbor embeddings based on the interim filtered user-user similarity dataset and a proxy set of user embeddings; (k) generating an interim set of item neighbor embeddings based on the interim filtered item-item similarity dataset and a proxy set of item embeddings; (l) generating a set of interim relevance scores based on the interim user neighbor embeddings and the interim item neighbor embeddings; (m) determining the loss based on the generate a set of interim relevance scores; (n) updating the interim user similarity threshold vector and interim item similarity threshold vector to minimize the loss; and repeating (i to n) until the interim user similarity threshold vector and interim item similarity threshold vector are optimized in respect of the proxy set of user embeddings and the proxy set of item embeddings. The inner optimization stage and the outer optimization stage are successively repeated during a plurality of training iterations.

In some examples, performing the training phase includes determining a plurality of triplets based on the input dataset, wherein each triplet identifies: (i) a respective user from the set of users; (ii) a positive item from the set of items that is deemed to be positive with respect to the respective user based on the user-item interaction data; and (iii) a negative item from the set of items that is deemed to be negative with respect to the respective user based on the user-item interaction data. Learning of the system parameters is performed to optimize an objective that maximizes, for the plurality of triplets, a difference between relevance scores computed for positive items with respect to users and relevance scores computed for negative items with respect to users.

Processing System

In example embodiment, the operations performed by RS 200 are computer implemented using one or more physical or virtual computing devices. In an example operation, the operations performed by the RS 200 may be software that forms part of a “software-as-a-service” of a cloud computing service provider.

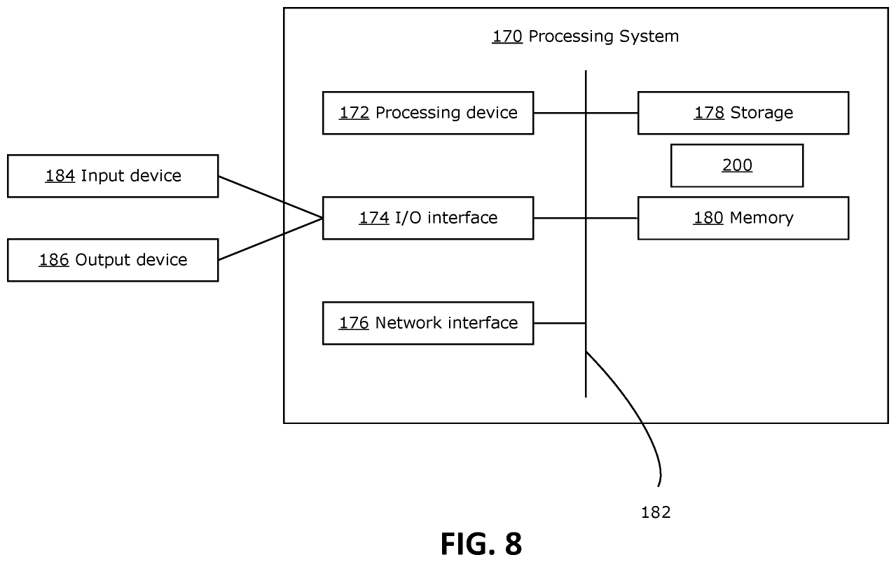

FIG. 8 is a block diagram of an example processing system 170, which may be used in a physical or virtual computer device to execute machine executable instructions to implement the operations of RS 200. Other processing systems suitable for implementing embodiments described in the present disclosure may be used, which may include components different from those discussed below. Although FIG. 8 shows a single instance of each component, there may be multiple instances of each component in the processing unit 170.

The processing system 170 may include a processing device 172 that comprises one or more processing elements, such as a processor, a microprocessor, a general processor unit (GPU), an artificial intelligence processor, tensor processing unit, neural processing unit, an application-specific integrated circuit (ASIC), a field-programmable gate array (FPGA), a dedicated logic circuitry, accelerator logic, or combinations thereof. The processing unit 170 may also include one or more input/output (I/O) interfaces 174, which may enable interfacing with one or more appropriate input devices 184 and/or output devices 186. The processing unit 170 may include one or more network interfaces 176 for wired or wireless communication with a network.

The processing system 170 may also include one or more storage devices 178, which may include a mass storage device such as a solid state drive, a hard disk drive, a magnetic disk drive and/or an optical disk drive. The processing system 170 may include one or more memories 180, which may include a volatile or non-volatile memory (e.g., a flash memory, a random access memory (RAM), and/or a read-only memory (ROM)). The memory(ies) 180 may store instructions for execution by the processing device(s) 172, such instructions that configure the processing unit 170 to implement the operations of RS 200 and carry out examples described in the present disclosure. The memory(ies) 180 may include other software instructions, such as for implementing an operating system and other applications/functions.

There may be a bus 182 providing communication among components of the processing system 170, including the processing device(s) 172, I/O interface(s) 174, network interface(s) 176, storage device(s) 178 and/or memory(ies) 180. The bus 182 may be any suitable bus architecture including, for example, a memory bus, a peripheral bus or a video bus.

Although the present disclosure describes methods and processes with steps in a certain order, one or more steps of the methods and processes may be omitted or altered as appropriate. One or more steps may take place in an order other than that in which they are described, as appropriate. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of all published papers identified in this disclosure are incorporated herein by reference.

1. A computer implemented method in an recommendation system for processing an input dataset that identifies a set of users, a set of items, and user-item interaction data about historic interactions between users in the set of users and items in the set of items, the computer implemented method comprising:
generating, based on the user-item interaction data, a user-user similarity dataset that indicates user-user similarity scores for pairs of users in the set of users;
generating, based on the user-item interaction data, an item-item similarity dataset that indicates item-item similarity scores for pairs of items in the set of items;
filtering the user-user similarity dataset based on a user similarity threshold vector to generate a filtered user-user similarity dataset, the user similarity threshold vector including a respective user similarity threshold value for each user in the set of users;
generating a set of user neighbour embeddings based on the filtered user-user similarity dataset and a set of user embeddings, the set of user embeddings including a respective user embedding for each user in the set of users;
filtering the item-item similarity dataset based on an item similarity threshold vector to generate a filtered item-item similarity dataset, the item similarity threshold vector including a respective item similarity threshold value for each item in the set of items;
generating a set of item neighbour embeddings based on the filtered item-item similarity dataset and a set of item embeddings, the set of item embeddings including a respective item embedding for each item in the set of items;
generating a set of relevance scores based on the user neighbour embeddings and the item neighbour embeddings, the set of relevance scores including, for each user in set of users, respective relevance scores for the items in the set of items; and
generating a list of one or more recommended items for each user based on the set of relevance scores.

2. The method of claim 1 further comprising collectively learning the user similarity threshold vector, the set of user embeddings, the item similarity threshold vector, and the set of item embeddings.

3. The method of claim 2 wherein collectively learning comprises performing a bilevel optimization process that includes an inner optimization stage for learning the user embeddings and item embeddings based on a lower-level objective function and an outer optimization stage for learning the user similarity threshold vector and item similarity threshold vector based on an upper level objective function.

4. The method of claim 3 wherein performing the bilevel optimization process comprises computing proxy embeddings for the user embeddings and the item embeddings and using the proxy embeddings during the outer optimization stage.

5. The method of claim 3 wherein:
the inner optimization stage for learning the user embeddings and item embeddings comprises:
(a) filtering the user-user similarity dataset based on an interim user similarity threshold vector to generate an interim filtered user-user similarity dataset; and
(b) filtering the item-item similarity dataset based on an interim item similarity threshold vector to generate an interim filtered item-item similarity dataset;
(c) generating an interim set of user neighbour embeddings based on the interim filtered user-user similarity dataset and an interim set of user embeddings;
(d) generating an interim set of item neighbour embeddings based on the interim filtered item-item similarity dataset and an interim set of item embeddings;
(e) generating a set of interim relevance scores based on the interim user neighbour embeddings and the interim item neighbour embeddings;
(f) determining a loss based on the generate a set of interim relevance scores;
(g) updating the interim set of user embeddings and interim set item embeddings to minimize the loss;
repeating (c to g) until the interim set of user embeddings and interim set of item embeddings are optimized in respect of the interim user similarity threshold vector and interim item threshold vector;
and
the outer optimization stage for learning the user similarity threshold vector and the item similarity threshold vector comprises:
(h) filtering the user-user similarity dataset based on an interim user similarity threshold vector to generate an interim filtered user-user similarity dataset;
(i) filtering the item-item similarity dataset based on an interim item similarity threshold vector to generate an interim filtered item-item similarity dataset;
(j) generating an interim set of user neighbour embeddings based on the interim filtered user-user similarity dataset and a proxy set of user embeddings;
(k) generating an interim set of item neighbour embeddings based on the interim filtered item-item similarity dataset and a proxy set of item embeddings;
(l) generating a set of interim relevance scores based on the interim user neighbour embeddings and the interim item neighbour embeddings;
(m) determining the loss based on the generate a set of interim relevance scores;
(n) updating the interim user similarity threshold vector and interim item similarity threshold vector to minimize the loss;
repeating (h to n) until the interim user similarity threshold vector and interim item similarity threshold vector are optimized in respect of the proxy set of user embeddings and the proxy set of item embeddings,
wherein the inner optimization stage and the outer optimization stage are successively repeated during a plurality of training iterations.

6. The method of claim 2 wherein collectively learning comprises:
determining a plurality of triplets based on the input dataset, wherein each triplet identifies: (i) a respective user from the set of users; (ii) a positive item from the set of items that is deemed to be positive with respect to the respective user based on the user-item interaction data; and (iii) a negative item from the set of items that is deemed to be negative with respect to the respective user based on the user-item interaction data;
learning the user similarity threshold vector, the set of user embeddings, the item similarity threshold vector, and the set of item embeddings to optimize an objective that maximizes, for the plurality of triplets, a difference between relevance scores computed for positive items with respect to users and relevance scores computed for negative items with respect to users.

7. The method of claim 1 wherein:
the user-user similarity scores for the pairs of users and the item-item similarity scores for the pairs of items are determined using a cosine similarity algorithm.

8. The method of claim 1 wherein:
filtering the user-user similarity dataset comprises, for each user:
replicating in the filtered user-user similarity dataset any of the user-user similarity scores for the user from the user-user similarity dataset that exceed the respective user similarity threshold value for the user, and
setting to zero in the filtered user-user similarity dataset any of the user-user similarity scores for the user from the user-user similarity dataset that do not exceed the respective user similarity threshold value for the user; and
filtering the item-item similarity dataset comprises, for each item:
replicating in the filtered item-item similarity dataset any of the item-item similarity scores for the item from the item-item similarity dataset that exceed the respective item similarity threshold value for the item, and
setting to zero in the filtered item-item similarity dataset any of the item-item similarity scores for the item from the item-item similarity dataset that do not exceed the respective item similarity threshold value for the item.

9. The method of claim 8 wherein:
generating the set of user neighbour embeddings comprises determining a dot product of a matrix representation of the filtered user-user similarity dataset and a matrix representation of the set of user embeddings; and
generating the set of item neighbour embeddings comprises determining a dot product of a matrix representation of the filtered item-item similarity dataset and a matrix representation of the set of item embeddings.

10. The method of claim 9 wherein generating the set of relevance scores comprises determining a dot product of a matrix representation of the set of user neighbour embeddings and a matrix representation of the set of item neighbour embeddings.

11. A recommendation system for processing an input dataset that identifies a set of users, a set of items, and user-item interaction data about historic interactions between users in the set of users and items in the set of items, the recommendation system comprising:
a processing device;
a non-transitory storage device coupled to the processing device and storing software instructions that when executed by the processing device configure the recommendation system to:
generate, based on the user-item interaction data, a user-user similarity dataset that indicates user-user similarity scores for pairs of users in the set of users;
generate, based on the user-item interaction data, an item-item similarity dataset that indicates item-item similarity scores for pairs of items in the set of items;
filter the user-user similarity dataset based on a user similarity threshold vector to generate a filtered user-user similarity dataset, the user similarity threshold vector including a respective user similarity threshold value for each user in the set of users;
generate a set of user neighbour embeddings based on the filtered user-user similarity dataset and a set of user embeddings, the set of user embeddings including a respective user embedding for each user in the set of users;
filter the item-item similarity dataset based on an item similarity threshold vector to generate a filtered item-item similarity dataset, the item similarity threshold vector including a respective item similarity threshold value for each item in the set of items;
generate a set of item neighbour embeddings based on the filtered item-item similarity dataset and a set of item embeddings, the set of item embeddings including a respective item embedding for each item in the set of items;
generate a set of relevance scores based on the user neighbour embeddings and the item neighbour embeddings, the set of relevance scores including, for each user in set of users, respective relevance scores for the items in the set of items; and
generate a list of one or more recommended items for each user based on the set of relevance scores.

12. The recommendation system of claim 11, wherein the non-transitory storage device stores further software instructions that when executed by the processing device configure the recommendation system to collectively learn the user similarity threshold vector, the set of user embeddings, the item similarity threshold vector, and the set of item embeddings.

13. The recommendation system of claim 12 wherein the non-transitory storage device stores further software instructions that when executed by the processing device configure the recommendation system to collectively learn the user similarity threshold vector, the set of user embeddings, the item similarity threshold vector, and the set of item embeddings by a bilevel optimization process that includes an inner optimization stage for learning the user embeddings and item embeddings based on a lower-level objective function and an outer optimization stage for learning the user similarity threshold vector and item similarity threshold vector based on an upper level objective function.

14. The recommendation system of claim 13 wherein:
the inner optimization stage for learning the user embeddings and item embeddings comprises:
(a) filtering the user-user similarity dataset based on an interim user similarity threshold vector to generate an interim filtered user-user similarity dataset; and
(b) filtering the item-item similarity dataset based on an interim item similarity threshold vector to generate an interim filtered item-item similarity dataset;
(c) generating an interim set of user neighbour embeddings based on the interim filtered user-user similarity dataset and an interim set of user embeddings;
(d) generating an interim set of item neighbour embeddings based on the interim filtered item-item similarity dataset and an interim set of item embeddings;
(e) generating a set of interim relevance scores based on the interim user neighbour embeddings and the interim item neighbour embeddings;
(f) determining a loss based on the generate a set of interim relevance scores;
(g) updating the interim set of user embeddings and interim set item embeddings to minimize the loss;
repeating (c to g) until the interim set of user embeddings and interim set of item embeddings are optimized in respect of the interim user similarity threshold vector and interim item threshold vector;
and
the outer optimization stage for learning the user similarity threshold vector and the item similarity threshold vector comprises:
(h) filtering the user-user similarity dataset based on an interim user similarity threshold vector to generate an interim filtered user-user similarity dataset;
(i) filtering the item-item similarity dataset based on an interim item similarity threshold vector to generate an interim filtered item-item similarity dataset;
(j) generating an interim set of user neighbour embeddings based on the interim filtered user-user similarity dataset and a proxy set of user embeddings;
(k) generating an interim set of item neighbour embeddings based on the interim filtered item-item similarity dataset and a proxy set of item embeddings;
(l) generating a set of interim relevance scores based on the interim user neighbour embeddings and the interim item neighbour embeddings;
(m) determining the loss based on the generate a set of interim relevance scores;
(n) updating the interim user similarity threshold vector and interim item similarity threshold vector to minimize the loss;
repeating (h to n) until the interim user similarity threshold vector and interim item similarity threshold vector are optimized in respect of the proxy set of user embeddings and the proxy set of item embeddings,
wherein the inner optimization stage and the outer optimization stage are successively repeated during a plurality of training iterations.

15. The recommendation system of claim 12 wherein the non-transitory storage device stores further software instructions that when executed by the processing device configure the recommendation system to collectively learn the user similarity threshold vector, the set of user embeddings, the item similarity threshold vector, and the set of item embeddings by:
determining a plurality of triplets based on the input dataset, wherein each triplet identifies: (i) a respective user from the set of users; (ii) a positive item from the set of items that is deemed to be positive with respect to the respective user based on the user-item interaction data; and (iii) a negative item from the set of items that is deemed to be negative with respect to the respective user based on the user-item interaction data; and
learning the user similarity threshold vector, the set of user embeddings, the item similarity threshold vector, and the set of item embeddings to optimize an objective that maximizes, for the plurality of triplets, a difference between relevance scores computed for positive items with respect to users and relevance scores computed for negative items with respect to users.

16. The recommendation system of claim 11 wherein:
the user-user similarity scores for the pairs of users and the item-item similarity scores for the pairs of items are determined using a cosine similarity algorithm.

17. The recommendation system of claim 11 wherein:
the recommendation system is configured to filter the user-user similarity dataset comprises, for each user, by:
replicating in the filtered user-user similarity dataset any of the user-user similarity scores for the user from the user-user similarity dataset that exceed the respective user similarity threshold value for the user, and
setting to zero in the filtered user-user similarity dataset any of the user-user similarity scores for the user from the user-user similarity dataset that do not exceed the respective user similarity threshold value for the user; and
the recommendation system is configured to filter the item-item similarity dataset comprises, for each item, by:
replicating in the filtered item-item similarity dataset any of the item-item similarity scores for the item from the item-item similarity dataset that exceed the respective item similarity threshold value for the item, and
setting to zero in the filtered item-item similarity dataset any of the item-item similarity scores for the item from the item-item similarity dataset that do not exceed the respective item similarity threshold value for the item.

18. The recommendation system of claim 17 wherein the non-transitory storage device stores further software instructions that when executed by the processing device configure the recommendation system to:
generate the set of user neighbour embeddings using a dot product of a matrix representation of the filtered user-user similarity dataset and a matrix representation of the set of user embeddings; and
generate the set of item neighbour embeddings using a dot product of a matrix representation of the filtered item-item similarity dataset and a matrix representation of the set of item embeddings.

19. The recommendation system of claim 17 wherein the non-transitory storage device stores further software instructions that when executed by the processing device configure the recommendation system to generate the set of relevance scores using a dot product of a matrix representation of the set of user neighbour embeddings and a matrix representation of the set of item neighbour embeddings.

20. A non-transitory computer-readable medium storing software instructions that, when executed by a processing device of a processing system, case the processing system to:
generating, based on the user-item interaction data, a user-user similarity dataset that indicates user-user similarity scores for pairs of users in the set of users;
generating, based on the user-item interaction data, an item-item similarity dataset that indicates item-item similarity scores for pairs of items in the set of items;
filtering the user-user similarity dataset based on a user similarity threshold vector to generate a filtered user-user similarity dataset, the user similarity threshold vector including a respective user similarity threshold value for each user in the set of users;
generating a set of user neighbour embeddings based on the filtered user-user similarity dataset and a set of user embeddings, the set of user embeddings including a respective user embedding for each user in the set of users;
filtering the item-item similarity dataset based on an item similarity threshold vector to generate a filtered item-item similarity dataset, the item similarity threshold vector including a respective item similarity threshold value for each item in the set of items;
generating a set of item neighbour embeddings based on the filtered item-item similarity dataset and a set of item embeddings, the set of item embeddings including a respective item embedding for each item in the set of items;
generating a set of relevance scores based on the user neighbour embeddings and the item neighbour embeddings, the set of relevance scores including, for each user in set of users, respective relevance scores for the items in the set of items; and
generating a list of one or more recommended items for each user based on the set of relevance scores.
